(19) United States
(12) Patent Application Publication
(10) Pub. No.: US 2004/0123141 A1
(43) Pub. Date: Jun. 24, 2004

(54) Multi-tier intrusion detection system

(76) Inventor: Satyendra Yadav, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/323,476

(22) Filed: Dec. 18, 2002

(51) Int. Cl. G06F 11/30

(52) U.S. Cl. 713/201

(57) ABSTRACT

A dynamic, multi-tier intrusion detection system for a computer network. The multi-tier intrusion detection system includes a global intrusion detection (GID) agent. A number of network intrusion detection (NID) agents may each be coupled with the GID agent, each NID agent being associated with a network. One or more local intrusion detection (LID) agents are coupled with each NID agent.

### FIELD OF THE INVENTION

The invention relates generally to intrusion detection in computer networks and, in particular, to a multi-tier intrusion detection system.

### BACKGROUND OF THE INVENTION

Since the advent of computer networking, the size of computer networks has steadily grown—both in terms of computing nodes and geography—to meet the demands of businesses and other large organizations, and such large networks are becoming increasingly vulnerable to attack. An attack, or network intrusion, may includes attempts to gain unauthorized access to network resources (e.g., databases) and/or attempts to interrupt network services (e.g., causing a system to “crash” or preventing authorized users from accessing a network). Maintaining accessibility to these vast networks, which may span multiple buildings and/or multiple work sites, while also addressing security concerns presents significant challenges to network engineers and information technology (IT) specialists.

To address the security concerns presented by unauthorized access (e.g., theft, interruption of service, etc.), network intrusion detection systems have been developed. However, a typical intrusion detection system is static in nature and takes a highly localized approach. As a result, conventional intrusion detection systems and methods are inadequate to meet the security needs of a large network including hundreds of geographically diverse users, some of which may be connected to the network over a wireless medium. In particular, these intrusion detection systems lack the ability to learn from past observations and mistakes, they do not dynamically adapt to changing circumstances, and they take a narrow view of the networking environment.

The inadequacies of conventional intrusion detection systems are exemplified by recent Internet worms such as Nimda and its predecessor Code Red. Each of the Nimda and Code Red worms took advantage of buffer overflow exploits in certain applications. Because of the Code Red worm, the networking community was aware of these buffer exploits prior to dissemination of the Nimda worm. However, despite this advance warning, intrusion detection systems often failed to detect Nimda.

There are many reasons for the failure of intrusion detection systems to detect the Nimda worm. As noted above, conventional intrusion detection systems are typically static, and they utilize fixed intrusion signatures. Generally, an intrusion signature comprises a data pattern that suggests an intrusion is occurring or is likely to occur. Once deployed, these fixed intrusion signatures could not be dynamically updated by IT administrators, even though the buffer exploits were known prior to Nimda, and a fixed intrusion signature can be bypassed with minor changes in the data pattern. In sum, intrusion detection systems do not include sufficient mechanisms to provide real-time feedback.

Furthermore, to the extent conventional intrusion detection systems attempt to collect and analyze data in real-time, they fail to take a global “view” of the networking environment. There is no centralized agent to collect intrusion data from a variety of sources, analyze this data from a broader perspective, and then provide real-time feedback to security managers. Having such a global view of the networking environment may be critical in some situations. For example, a single instance of abnormal behavior occurring at one node or within one network may be ignored by an intrusion detection system. However, multiple instances of this behavior spread across many computing nodes and/or networks may suggest suspicious activity requiring preventive measures (e.g., shutting down an application, closing an open channel, etc.), yet this potential threat may go undetected without a global perspective of the networking environment.

### BRIEF DESCRIPTION OF THE DRAWINGS

FIG. 1 is a schematic diagram illustrating a network including an embodiment of a multi-tier intrusion detection system.

FIG. 2 is a schematic diagram of an embodiment of a computer system which may be used to implement the disclosed embodiments.

FIG. 3 is a schematic diagram illustrating an embodiment of a multi-tier intrusion detection system.

FIG. 4 is a schematic diagram illustrating an embodiment of a sensor rule.

FIG. 5 is a block diagram illustrating an embodiment of a method of providing multi-tier intrusion detection.

### DETAILED DESCRIPTION OF THE INVENTION

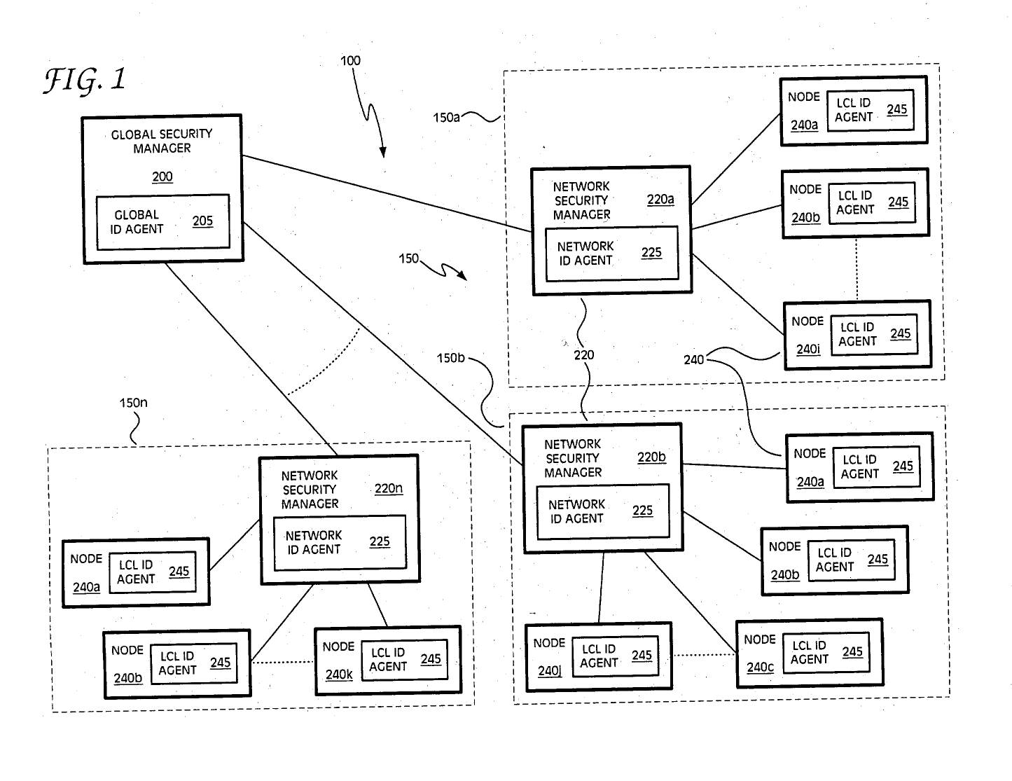

Illustrated in FIG. 1 is an embodiment of a network 100. The network 100 comprises a collection of networks 150, including networks 150a, 150b, . . . , 150n. Each of the networks 150 may comprise a Local Area Network (LAN), a Metropolitan Area Network (MAN), a Wide Area Network (WAN), a Wireless LAN (WLAN), or other network. The networks 150a-n, respectively, are coupled with a global security manager 200, the global security manager 200 including a global intrusion detection (GID) agent 205, which will be explained in more detail below. The global security manager 200 may be implemented on any suitable computer system (e.g., a server).

Each of the networks 150a-n includes a network security manager 220 (i.e., network 150a includes a network security manager 220a, network 150b includes a network security manager 220b, and so on) that is coupled with the global security manager 200. Each of the network security managers 220a-n includes a network intrusion detection (NID) agent 225, the operation of which is explained in more detail below. The connection between a network security manager 220 and the global security manager 200 may be established over any suitable medium—e.g., wireless, copper wire, fiber optic, or a combination thereof— using any suitable protocol—e.g., TCP/IP (Transmission Control Protocol/Internet Protocol), HTTP (Hyper-Text Transmission Protocol), as well as others. A network security manager 220 may be implemented on any suitable computer system (e.g., a server).

One or more nodes 240 are coupled with each of the network security managers 220a-n. For example, in network 150a, nodes 240a, 240b, . . . , 240i are coupled with network security manager 220a, and in network 150b, nodes 240a, 240b, . . . , 240j are coupled with network security manager 220b, whereas in network 150n, nodes 240a, 240b, . . . , 240k are coupled with network security manager 220n. Each node 240 includes a local intrusion detection (LID) agent 245, which will be explained in more detail below. A node 240 may comprise any type of computer system or other computing device, such as, by way of example, a server, a desktop computer, a laptop computer, or a hand-held computing device (e.g., a personal digital assistant or PDA). The connection between a node 240 and its corresponding network security manager 220 may be established over any suitable medium—e.g., wireless, copper wire, fiber optic, or combination thereof using any suitable protocol—e.g., TCP/IP (Transmission Control Protocol/Internet Protocol), HTTP (Hyper-Text Transmission Protocol), as well as others.

It should be understood that the network 100 is intended to represent an exemplary embodiment of such a system and, further, that the network 100 may have any suitable configuration. It should also be understood that each of the networks 150a-n represents an exemplary embodiment of a computer network, and it will be appreciated that each of the networks 150a-n may have an alternative configuration. For example, a network 150 may comprise any suitable number of nodes 240, and a network 150 may include additional devices (e.g., switches, routers, etc.) that have been omitted from the figures for ease of understanding.

The GID agent 205 in combination with the NID agents 225 and the LID agents 245 provide a dynamic, three-tier intrusion detection system. This three-tier intrusion detection system provides a global view of the networking environment, and the system can adapt in real-time to changing conditions. In one embodiment, the global security manager 200 is associated with a service provider that is providing security services to each of the networks 150a-n, and the global security manager may be located at the service provider's premises. Each of the networks 150a-n may comprise an enterprise network (i.e., a network associated with a business, corporation, or other organization) that receives security services from the security service provider.

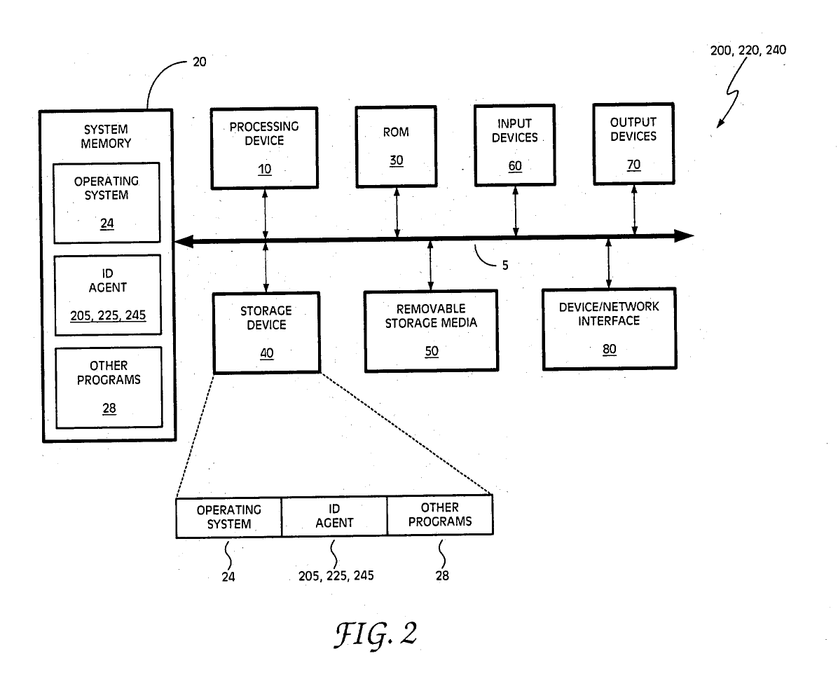

In one embodiment, each of the GID agent 205, the NID agents 225, and the LTD agents 245, respectively, comprises a software application that may be implemented or executed on any suitable computer system. An embodiment of such a computer system is illustrated in FIG. 2, and this computer system may comprise the global security manager 200, a network security manager 220, or a node 240.

Referring to FIG. 2, the computer system 200, 220, 240 includes a bus 5 having a processing device (or devices) 10 coupled therewith. Computer system 200, 220, 240 also includes system memory 20 coupled with bus 5, the system memory 20 comprising, for example, any suitable type of random access memory (RAM). During operation of computer system 200, 220, 240, an operating system 24, the intrusion detection agent 205, 225, 245, as well as other programs 28 may be resident in the system memory 20. It should be understood that, according to the notation used in FIG. 2, the illustrated system may comprise the global security manager 200 having the GID agent 205, a network security manager 220 having a NID agent 225, or a node 240 having a LID agent 245.

Computer system 200, 220, 240 may further include a read-only memory (ROM) 30 coupled with the bus 5. During operation, the ROM 30 may store temporary instructions and variables for processing device 10, and ROM 30 may also have resident thereon a system BIOS (Basic Input/Output System). The computer system 200, 220, 240 may also include a storage device 40 coupled with the bus 5. The storage device 40 comprises any suitable non-volatile memory, such as, for example, a hard disk drive. The intrusion detection agent 205, 225, 245, as well as operating system 24 and other programs 28, may be stored in the storage device 40. Further, a device 50 for accessing removable storage media— e.g., a floppy disk drive or a CD ROM drive—may be coupled with bus 5.

The computer system 200, 220, 240 may include one or more input devices 60 coupled with the bus 5. Common input devices 60 include keyboards, pointing devices such as a mouse, and scanners or other data entry devices. One or more output devices 70 may also be coupled with the bus 5. Common output devices 70 include video monitors, printing devices, and audio output devices (e.g., a sound card and speakers).

Computer system 200, 220, 240 further comprises a device and/or network interface 80 coupled with bus 5. For global security manager 200, the interface 80 comprises any suitable hardware, software, or combination of hardware and software capable of coupling the global security manager 200 with each of the network security managers 220, thereby allowing the GID agent 205 to communicate with each of the NID agents 225. For a network security manager 220, the interface 80 comprises any suitable hardware, software, or combination of hardware and software capable of coupling the network security manger 220 with the global security manager 200, such that the network security manager's NID agent 225 can communicate with the GID agent 205. The interface 80 of a network security manager 220 further comprises any suitable hardware, software, or combination thereof capable of coupling the network security manager 220 with each node 240 in the corresponding network 150, thereby allowing the LID agent 245 of each node 240 to communicate with the NID agent 225. Also, for a node 240, the interface 80 comprises any suitable hardware, software, or combination of hardware and software capable of coupling the node 240 with that node's network security manager 220, such that the node's LID agent 245 may communicate with the NID agent 225 of the network security manager 220.

It should be understood that the computer system 200, 220, 240 illustrated in FIG. 2 is intended to represent an exemplary embodiment of such a computer system and, further, that this computer system may include many additional components, which have been omitted for clarity and ease of understanding. By way of example, the computer system 200, 220, 240 may include a DMA (direct memory access) controller, a chip set associated with the processing device 10, additional memory (e.g., a cache memory), as well as additional signal lines and buses. Also, it should be understood that the computer system 200, 220, 240 may not include all of the components shown in FIG. 2.

In one embodiment, the GID agent 205 comprises a set of instructions i.e., a software application—run on global security manager 200 (e.g., the computer system of FIG. 2 or other suitable computing device). The set of instructions may be stored locally in storage device 40 or, alternatively, the instructions may be stored in a remote storage device (not shown in figures) and accessed via network 100. During operation, the set of instructions may be executed on processing device 10, wherein the instructions (or a portion thereof) may be resident in system memory 20.

In another embodiment, the GID agent 205 comprises a set of instructions stored on a machine accessible medium, such as, for example, a magnetic media (e.g., a floppy disk or magnetic tape), an optically accessible disk (e.g., a CD-ROM disk), a flash memory device, etc. To run GID agent 205 on global security manager 200, the device 50 for accessing removable storage media may access the instructions on the machine accessible medium, and the instructions may then be executed in processing device 10. In this embodiment, the instructions (or a portion thereof) may again be downloaded to system memory 20.

Similarly, a NID agent 225 may, in one embodiment, comprise a set of instructions run on a network security manager 220 (e.g., the computer system of FIG. 2 or other suitable computing device). The set of instructions may be stored locally in storage device 40 or, alternatively, the instructions may be stored in a remote storage device (not shown in figures) and accessed via the network 150 associated with the network security manager 220 (or network 100). During operation, the set of instructions may be executed on processing device 10, wherein the instructions (or a portion thereof) may be resident in system memory 20.

In a further embodiment, a NID agent 225 comprises a set of instructions stored on a machine accessible medium, such as, for example, a magnetic media (e.g., a floppy disk or magnetic tape), an optically accessible disk (e.g., a CD-ROM disk), a flash memory device, etc. To run NID agent 225 on a network security manager 220, the device 50 for accessing removable storage media may access the instructions on the machine accessible medium, and the instructions may then be executed in processing device 10. In this embodiment, the instructions (or a portion thereof) may again be downloaded to system memory 20.

Also, in one embodiment, a LID agent 245 comprises a set of instructions run on a node 240 (e.g., the computer system of FIG. 2 or other suitable computing device). The set of instructions may be stored locally in storage device 40 or, alternatively, the instructions may be stored in a remote storage device (not shown in figures) and accessed via the network 150 to which the node 240 is connected. During operation, the set of instructions may be executed on processing device 10, wherein the instructions (or a portion thereof) may be resident in system memory 20.

In yet a further embodiment, a LID agent 245 comprises a set of instructions stored on a machine accessible medium, such as, for example, a magnetic media (e.g., a floppy disk or magnetic tape), an optically accessible disk (e.g., a CD-ROM disk), a flash memory device, etc. To run LID agent 245 on a node 240, the device 50 for accessing removable storage media may access the instructions on the machine accessible medium, and the instructions may then be executed in processing device 10. In this embodiment, the instructions (or a portion thereof) may again be downloaded to system memory 20.

In another embodiment, any one (or more) of the GID agent 205, a NID agent 225, and a LID agent 245 is implemented in hardware or a combination of hardware and software (e.g., firmware). For example, the GID agent 205 may be implemented in an ASIC (Application Specific Integrated Circuit), FPGA (Field Programmable Gate Array), a network processor, or other similar device that has been programmed in accordance with the disclosed embodiments. Similarly, a NID agent 225 may be implemented in an ASIC, an FPGA, a network processor or similar device programmed in accordance with the disclosed embodiments, and a LID agent 245 may be implemented in an ASIC, an FPGA, a network processor, or similar device programmed in accordance with the disclosed embodiments.

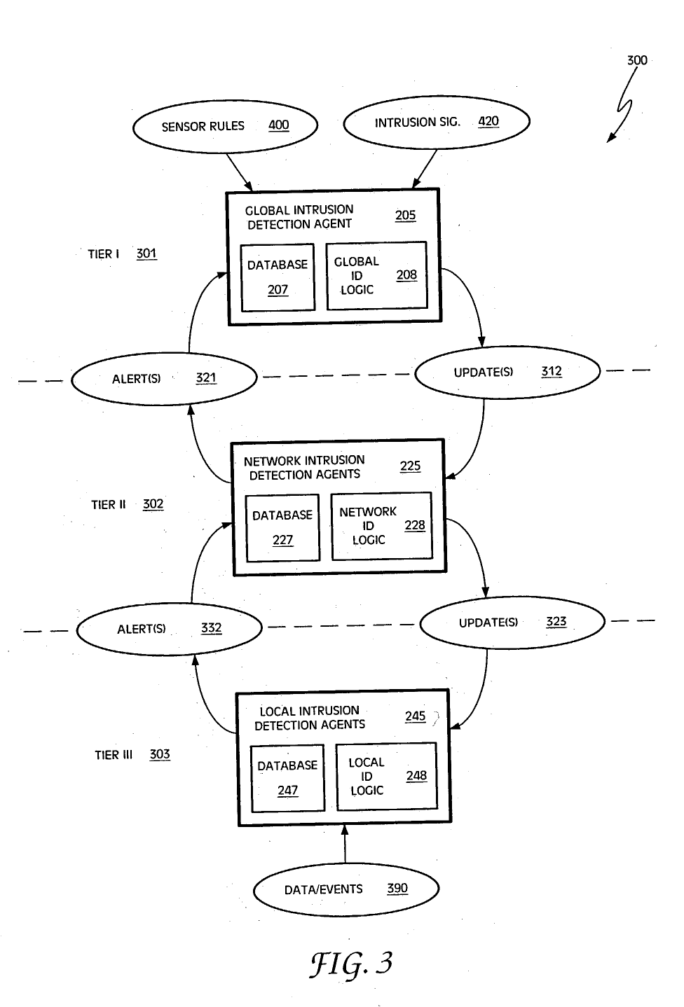

Turning now to FIG. 3, an embodiment of a three-tier intrusion detection system 300 is illustrated. In one embodiment, as shown in FIG. 3, the intrusion detection system 300 comprises a first tier 301, a second tier 302, and a third tier 303. The first tier 301 of multi-tier intrusion detection system 300 includes the GID agent 205. Second tier 302 of intrusion detection system 300 includes the NID agents 225 coupled with GID agent 205, whereas the third tier 303 includes the LID agents 245 coupled with each of the NID agents 225. Each of the GID agent 205, the NID agents 225, and the LID agents 245 includes (or can access) a database 207, 227, 247, respectively.

The GID agent 205 receives sensor rules 400 and intrusion signatures 420 from a variety of sources (e.g., security analysts, 3^{rd} party intrusion signature developers, etc.) and stores this information in database 207. If necessary, GID agent 205 can translate this information into a format suitable for intrusion detection system 300. The GID agent 205 provides these sensor rules 400—and intrusion signatures 420, which typically form part of a sensor rule, as will be explained below—to the NID agents 225 which, in turn, provide the sensor rules to their respective LID agents 245. The NID agents 225 and LID agents 245 store the sensor rules 400 in their respective databases 227, 247.

Generally, an intrusion signature 420 comprises any circumstance or set of circumstances that indicate a network intrusion is occurring or is imminent. For example, an intrusion signature may comprise any data pattern (found in a single packet or gleaned from multiple packets or other communications) that suggests a network communication is associated with a network intrusion. In one embodiment, an intrusion signature comprises one of four types: system level intrusion signatures, run first intrusion signatures, application specific intrusion signatures, and default intrusion signatures. System level intrusion signatures apply to system and network level activities that are not directly tied to an application (e.g., Address Resolution Protocol, or ARP, requests, Domain Name System, or DNS, requests, etc.). Run first intrusion signatures are applied first to every application, whereas an application-specific intrusion signature is applied to only a specific application. Default intrusion signatures apply generally to any unrecognized application.

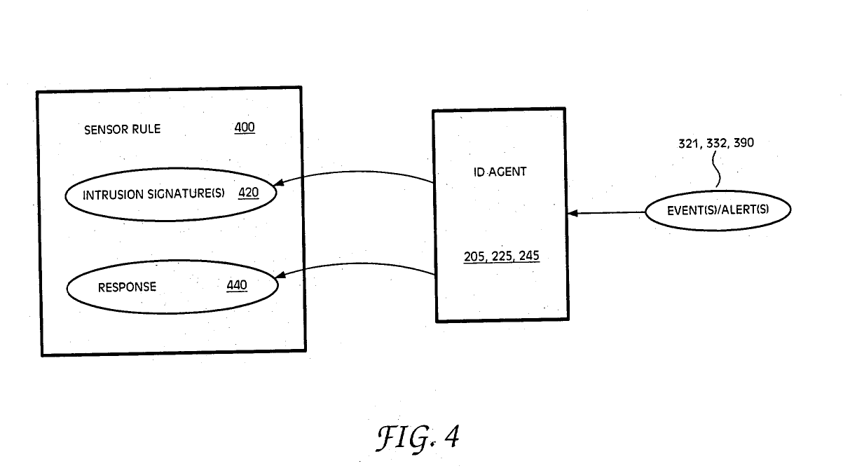

A sensor rule 400 is analogous to a sensor in the physical world (e.g., an acceleration sensor). As shown in FIG. 4, a sensor rule 400 includes an intrusion signature (or signatures) 420 and a response 440. The intrusion signature(s) 420 represents the activity (e.g., an abnormal data pattern) that the sensor rule 400 is “looking” for. If an activity or other circumstance corresponding to the intrusion signature(s) of the sensor rule is detected, the response 440 is triggered. The response 440 may include, by way of example, shutting down an application, closing an open channel, or other action. As suggested by FIG. 4, a sensor rule 400 can be modified including the intrusion signature 420 as well as the response 440 by any one of the GID agent 205, the NID agents 225, and the LID agents 245 in response to a detected event or an alert, as will now be explained.

Returning to FIG. 3, each LID agent 245 in the third tier 303 has a local view of the networking environment. In one embodiment, each LID agent 245 includes logic 248— this logic being optimized for this tier of the intrusion detection system 300— that may perform some or all of the functions described below.

Each LID agent 245 monitors the network traffic that it receives looking for any anomalies or other circumstance corresponding to a sensor rule stored in that LID agent's database 247. A LID agent 245 may perform application-specific detection, packet level detection, and/or other detection schemes. For application-specific detection, the LID agent 245 looks at packets associated with a specific application that has been invoked and attempts to detect communications (e.g., responses) that appear abnormal for this application. In packet level, or system level, detection, the LID agent 245 looks at all packets (or a subset of packets) that arrive at the node and attempts to detect any anomalies at the system or network level (e.g., malformed packets or packets that otherwise do not conform to a protocol).

During operation, a LID agent 245 at a node 240 may detect an event or other data 390 corresponding to an intrusion signature associated with a sensor rule stored in that LID agent's database 247. In response to the detected event 390, the LID agent 245 may analyze the data and generate a new intrusion signature and sensor rule and/or modify an existing sensor rule, and then store this new or modified sensor rule in its database 247. Also, in response to the detected event 390, the LID agent 245 may transmit an alert 332 to a NID agent 225, thereby providing the NID agent 225 with real-time intrusion data regarding the NID agent's network 150. The alert 332 may include raw data and/or the new or modified sensor rule developed by the LID agent 245. In another embodiment, the LID agent 245 does not send an alert to the NID agent 225 in response to each detected event. Rather, the LID agent 245 may collect data associated with multiple events, consolidate the information it collects into a single report, which the LID agent 245 then transmits to the NID agent 225 in the form of an alert 332.

Each NID agent 225 of the second tier 302 has a network level view of the networking environment. In one embodiment, each NID agent 225 includes logic 228 optimized for the second tier 302 of the multi-tier intrusion detection system 300, and this logic 228 may perform some or all of the functions described below.

Each NID agent 225 will receive alerts 332 from all LID agents 245 in that NID agent's network 150. In response to an alert 332 received from a LID agent 245, a NID agent 225 may analyze the data it receives and generate a new intrusion signature and sensor rule and/or modify an existing sensor rule, and then store this new or modified sensor rule in its database 227. The NID agent 225 may then send an update 323 to all LID agents 245 in the corresponding network 150. The update 323 may include the new or modified sensor rule, one or more intrusion signatures (both new and modified), as well as raw data that the NID agent 225 has received. By providing the updates 323 to the LID agents 245, the LID agents 245 receive dynamic feedback—including new and/or modified sensor rules and intrusion signatures thereby enabling the LID agent 245 at each node 240 to adapt in real-time to changes in the network environment.

Further, in response to the alert 332, the NID agent 225 may transmit an alert 321 to the GID agent 205, thereby providing the GID agent 205 with real-time intrusion data regarding the NID agent's network 150. The alert 321 may include raw data, the new or modified sensor rule developed by the NID agent 225, and/or one or more intrusion signatures (either new or modified). In another embodiment, the NID agent 225 does not send an alert 321 to the GID agent 205 in response to each alert 332 it receives from a LID agent 245. Rather, the NID agent 225 may collect multiple alerts 332 (e.g., a number of alerts 332 received from a number of different LID agents 245), consolidate the information it collects, and then transmit the collected information to the GID agent 205 in the form of an alert 321.

The alert 321 transmitted from a NID agent 225 to the GID agent 205 may be similar in content to the alert 332 that the NID agent 225 receives from a LID agent 245. However, it should be understood that the alerts 332 provided the LID agents 245 and the alerts 321 provided by the NID agents 225 may not be the same. In general, the information gathered, received, and/or stored at a tier of the multi-tier intrusion detection system 300 may be optimized for that tier.

The GID agent 205 provides a global view of the networking environment and, therefore, it is the GID agent 205 that has the broadest perspective of the network environment. In one embodiment, the GID agent 205 includes logic 208 that may perform some or all of the functions described below. The GID agent logic 208 may be optimized for the first tier 301 of multi-tier intrusion detection system 300.

The GID agent 205 will receive alerts 321 from the NID agents 225 in the network 100, as described above. In response to an alert 321 received from a NID agent 225, the GID agent 205 may analyze the data it receives and generate a new intrusion signature and sensor rule and/or modify an existing sensor rule, and then store this new or modified sensor rule in its database 207. The GID agent 205 may then send an update 312 to all NID agents 225 in the network 100. This update 312 may include the new or modified sensor rule, one or more intrusion signatures (both new and modified), and/or raw data that the GID agent 205 has received. The updates 312 may be provided to the NID agents 225 in real-time, such that the database 227 of each NID agent 225 can be dynamically updated with new and/or modified sensor rules and intrusion signatures.

In response to receipt of an update 312 from the GID agent 205, each NID agent 225 receiving the update 312 may provide an update 323 to each LID agent 245 in that NID agent's network 150. In one embodiment, the update 323 transmitted from a NID agent 225 to one or more LID agents 245 is similar in content to the update 312 received from the GID agent 205. However, it should be understood that the updates 312 provided by the GID agent 205 and the updates 323 provided by the NID agents 225 may not be the same. Once again, the information gathered, received, and/or stored at a tier of the multi-tier intrusion detection system 300 may be optimized for that tier.

In sum, the GID agent 205 can collect alerts and other intrusion data from many locations across the network 100 and, because of the dynamic updates provided by GID agent 205 as well as those provided by the NID agents 225, each NID agent 225 and the LID agents 245 coupled therewith can adapt in real-time to changes in the network environment. Thus, as illustrated in FIG. 4, in response to a detected event 390 and/or one or more alerts 321, 332, a sensor rule 400 may be modified (or a new sensor rule created) by any one of the GID agent 205, a NID agent 225, or a LID agent 245. Both the intrusion signature 420 and/or the response 440 of a sensor rule 400 may be updated by one of the intrusion detection agents 205, 225, 245. It should be understood that a sensor rule 400 may be stored in the database 207 of GID agent 205, the database 227 of one or more NID agents 225, and/or the database 247 of one or more LID agents 245. It should also be understood that the sensor rule 400 may be modified while residing at any tier 301, 302, 303 of the multi-tier intrusion detection system 300 and that any change to that rule may be propagated to the other tiers of system 300.

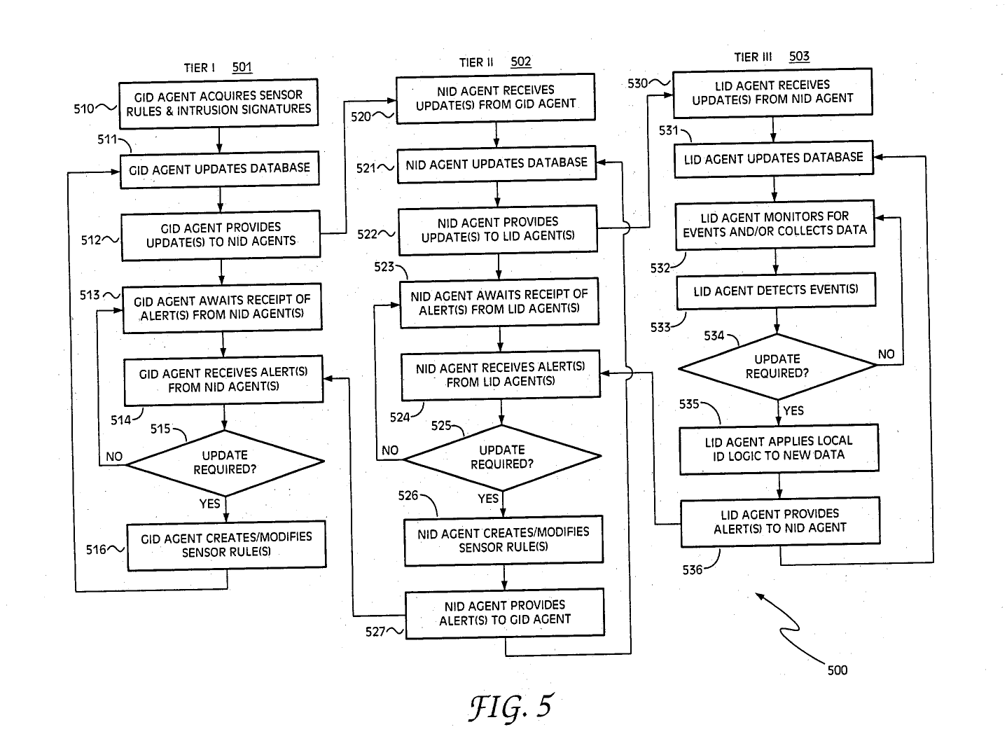

The multi-tier intrusion detection system 300 may be better understood with reference to FIG. 5, which illustrates one embodiment of a method 500 of providing multi-tier intrusion detection. To illustrate the interaction between each tier 301, 302, 303 of the multi-tier intrusion detection system 300, the functions performed by each of the GID, NID, and LID agents 205, 225, 245, respectively, are shown in FIG. 5. Those operations typically performed by GID agent 205 are presented in column 501, those operations typically performed by a NID agent 225 are presented in column 502, and those operations typically performed by a LID agent 245 are presented in column 503.

Referring to block 510 in FIG. 5, the GID agent 205 acquires sensor rules and intrusion signatures from a number of sources (e.g., security analysts, 3^{rd} party security service vendors, etc.), and the GID agent 205 stores these rules in it's database, as shown at block 511. The GID agent 205 may then transmit these sensor rules to the NID agents 225, which is illustrated at block 512. Referring to block 513, the GID agent 205 awaits receipt of alerts from the NID agents 225. When the GID agent 205 receives an alert (or alerts) from one or more NID agents 225— see block 514— the GID agent 205 analyzes the received information to determine whether an update is required, as shown at block 515. If no update is necessary (see block 515), the GID agent 205 continues to monitor for alerts received from the NID agents 225 (see block 513).

However, if an update is required in response to the received alert(s) (see block 515), the GID agent 205 creates and/or modifies one or more sensor rules (or intrusion signatures), as shown at block 516. Referring again to blocks 511 and 512, the GID agent 205 updates its database with the new or modified sensor rule(s) and then transmits an update to each NID agent 225. The update may include the new or modified sensor rule(s) as well as other information.

Referring now to block 520, a NID agent receives an update (or updates) from the GID agent 205. The update may include sensor rules provided by other sources (e.g., security analysts, 3^{rd} party vendors, etc.), or the update may include new and/or modified sensor rules generated by GID agent 205 in response to an alert, as well as other information. The NID agent 225 updates it's database, which is shown at block 521, and then the NID agent may provide an update to all LID agents 245 coupled therewith, as illustrated at block 522. The update transmitted from the NID agent 225 to the LID agents 245 may include content similar to that of the update the NID agent 225 received from GID agent 205. Again, however, the information gathered, received, and/or stored at a given tier of the intrusion system 300 may be optimized for that level, and an update sent by a NID agent 225 may not be identical in content to an update received by that NID agent.

As shown at block 523, the NID agent 225 awaits receipt of one or more alerts from the LID agents 245 in the NID agent's network 150. If the NID agent 225 receives an alert (or alerts) from one or more LID agents—see block 524— the NID agent will analyze the received information to determine whether an update is required, which is illustrated by block 525. If no update is needed (see block 525), the NID agent 225 continues to monitor for alerts received from the LID agents 245 (see block 523).

Conversely, if an update is required (see block 525), the NID agent creates and/or modifies one or more sensor rules (or intrusion signatures), as shown at block 526. Referring to block 527, the NID agent 225 may then provide an alert to the GID agent 205. The alert may include the new or modified sensor rule(s) and/or raw data, as well as any other information. With reference again to blocks 521 and 522, the NID agent 225 updates its database with the new and/or modified sensor rule(s) and also provides an update to each LID agent 245 in the corresponding network 150.

Referring to block 530, a LID agent 245 may receive an update from the NID agent 225 to which it is coupled. The update may include sensor rules provided by other sources (e.g., security analysts, 3^{rd} party vendors, etc.), or the update may include new and/or modified sensor rules generated by GID agent 205 and/or NID agent 225 in response to one or more alerts. The LID agent 245 updates it's database to include this new or updated information, which is shown at block 531.

As illustrated at block 532, the LID agent 245 monitors for events and/or collects data. The events or data the LID agent 245 attempts to detect correspond to the sensor rules and intrusion signatures stored in its database. When the LID agent 245 detects an event (e.g., a data pattern or other anomaly corresponding to an intrusion signature)— see block 533— the LID agent analyzes the data to determine whether an update is required, which is shown at block 534. If no update is required (see block 534), the LID agent 245 continues to monitor for events and/or gather data (see block 532). It should be understood that, in response to a detected event, the LID agent 245 may also trigger an appropriate response 440 (e.g., shutting down an application, closing an open channel, etc.).

If, however, an update is necessary (see block 534), the LID agent 245 can create or modify one or more sensor rules, as illustrated at block 535. The LID agent 245 may then provide an alert to the NID agent 225, which is shown at block 536. The alert may include the new or modified sensor rule(s) and/or raw data, as well as any other information. In response to this alert, the NID agent 225 may provide an alert to the GID agent 205 (see blocks 524-527), as previously described. The alerts received by the NID agent 225 and those alerts sent by the NID agent may not be identical in content. Once again, as noted above, the information gathered, received, and/or stored at any given tier of the multi-tier intrusion detection system 300 may be optimized for that tier. Referring again to block 531, the LID agent 245 may update it's database with the new and/or modified sensor rule(s).

A multi-tier intrusion detection system 300, as well as a method 500 of performing multi-tier intrusion detection, having been herein described with respect to FIGS. 1 through 5, those of ordinary skill in the art will appreciate the advantages thereof. A multi-tier architecture provides a broader view of the networking environment and facilitates real-time transfer of data throughout all levels of a network. Intrusion data from a wide array of sources can be gathered at a central location for analysis. Thus, where an isolated occurrence may have gone undetected in conventional intrusion detection systems, when viewed globally by the multi-tier intrusion detection system, the detection of a number of similar anomalies may suggest an attack. Further, data is readily shared between tiers, and intrusion signatures and/or sensor rules can be dynamically updated and new signatures and rules easily propagated to lower levels of a network.

The foregoing detailed description and accompanying drawings are only illustrative and not restrictive. They have been provided primarily for a clear and comprehensive understanding of the disclosed embodiments and no unnecessary limitations are to be understood therefrom. Numerous additions, deletions, and modifications to the embodiments described herein, as well as alternative arrangements, may be devised by those skilled in the art without departing from the spirit of the disclosed embodiments and the scope of the appended claims.

What is claimed is:

1. A system comprising:
a global intrusion detection (GID) agent, the GID agent to generate an update in response to first received information;
a number of network intrusion detection (NID) agents, each of the NID agents coupled with the GID agent, each NID agent to generate an alert in response to second received information; and
a number of local intrusion detection (LID) agents, each of the LID agents coupled with one of the NID agents, each LID agent to generate an alert in response to a detected event.

2. The system of claim 1, wherein the first received information includes the alert provided by one of the NID agents.

3. The system of claim 1, further comprising a database associated with the GID agent.

4. The system of claim 3, wherein the database has an intrusion signature stored therein.

5. The system of claim 4, wherein the GID agent modifies the intrusion signature based upon the first received information and the update includes the modified intrusion signature.

6. The system of claim 4, wherein the intrusion signature comprises part of a sensor rule.

7. The system of claim 1, wherein the GID agent creates an intrusion signature based upon the first received information and includes the created intrusion signature in the update.

8. The system of claim 1, wherein the GID agent provides the update to each of the NID agents.

9. The system of claim 1, wherein the second received information includes the alert provided by one of the LID agents.

10. The system of claim 1, further comprising a database associated with each of the NID agents.

11. The system of claim 10, the database of each NID agent to store the update received from the GID agent.

12. The system of claim 1, each NID agent to generate an update in response to the second received information.

13. The system of claim 12, each NID agent to provide the update to each LID agent coupled therewith.

14. The system of claim 1, further comprising a database associated with each of the LID agents.

15. A method comprising:
running a global intrusion detection (GID) agent on a first computer system;
running a network intrusion detection (NID) agent on each of a number of second computer systems, each second computer system coupled with the first computer system; and
running a local intrusion detection (LID) agent on each of a number of computing nodes, each computing node coupled with one of the second computer systems;

16. The method of claim 15, further comprising providing a sensor rule to the GID agent.

17. The method of claim 16, further comprising storing the sensor rule in a database of the GID agent.

18. The method of claim 15, further comprising transmitting an update from the GID agent to each of the NID agents.

19. The method of claim 18, further comprising storing the update in a database of each NID agent.

20. The method of claim 18, wherein the update includes an intrusion signature.

21. The method of claim 15, further comprising transmitting an update from one of the NID agents to the LID agents coupled with the one NID agent.

22. The method of claim 21, further comprising storing the update in a database of each of the LID agents coupled with the one NID agent.

23. The method of claim 21, wherein the update includes an intrusion signature.

24. The method of claim 15, further comprising:
detecting an event at one of the LID agents;
generating an alert in response to the detected event; and
transmitting the alert from the one LID agent to the NID agent of the one second computer system.

25. The method of claim 24, further comprising:
generating an update at the NID agent of the one second computer system in response to the alert; and
transmitting the update to each computing node coupled with the one second computer system.

26. The method of claim 15, further comprising:
receiving a number of alerts at one of the NID agents, each of the alerts received from one of the LID agents;
generating a second alert in response to the received alerts; and
transmitting the second alert from the one NID agent to the GID agent.

27. The method of claim 26, further comprising:
generating an update at the GID agent in response to the second alert; and
transmitting the update to the NID agent on each of the second computer systems.

28. A method comprising:
monitoring for the occurrence of an event at one of a number of local intrusion detection (LID) agents, each of the LID agents coupled with a network intrusion detection (NID) agent;
transmitting a first alert from the one LID agent to the NID agent in response to detection of the event, the NID agent coupled with a global intrusion detection (GID) agent; and
transmitting a second alert from the NID agent to the GID agent in response to the first alert.

29. The method of claim 28, wherein the second alert is transmitted in response to the first alert and at least one other alert received from one of the LID agents.

30. The method of claim 28, wherein the first alert is transmitted in response to detection of the event and detection of at least one more of the events.

31. The method of claim 28, wherein the event corresponds to an intrusion signature.

32. The method of claim 28, further comprising:
generating an update at the GID agent in response to the second alert; and
transmitting the update from the GID agent to the NID agent and a number of other NID agents.

33. The method of claim 32, further comprising transmitting another update from the NID agent to each of the LID agents in response to receipt of the update from the GID agent.

34. The method of claim 28, further comprising:
generating an update at the NID agent in response to receipt of the first alert; and
transmitting the update from the NID agent to each of the LID agents.

35. The method of claim 28, further comprising modifying a database of the GID agent in response to the second alert.

36. The method of claim 28, further comprising modifying a database of the NID agent in response to the first alert.

37. The method of claim 28, further comprising modifying a database of the one LID agent in response to detection of the event.

38. An intrusion detection system comprising:
a first tier, the first tier including a global intrusion detection (GID) agent running on a first computer system;
a second tier, the second tier including a number of network intrusion detection (NID) agents, each of the NID agents running on one of a number of second computer systems, each second computer system coupled with the first computer system; and
a third tier, the third tier including a number of local intrusion detection (LID) agents, each LID agent running on a computing node coupled with one of the second computer systems.

39. The intrusion detection system of claim 38, wherein each of the second computer systems and the computing nodes coupled therewith comprises a network.

40. The intrusion detection system of claim 39, wherein the network comprises an enterprise network.

41. A product comprising:
a first machine accessible medium providing content that, when accessed by a first machine, causes the first machine to provide a global intrusion detection agent;
a second machine accessible medium providing content that, when accessed by a second machine, causes the second machine to provide a network intrusion detection agent, the second machine coupled with the first machine; and
a third machine accessible medium providing content that, when accessed by a third machine, causes the third machine to provide a local intrusion detection agent, the third machine coupled with the second machine.

42. The product of claim 41, wherein the second machine and the third machine are associated with a network.

43. The product of claim 42, wherein the network comprises one of a local area network (LAN), a metropolitan area network (MAN), a wide area network (WAN), and a wireless LAN (VLAN).

44. The product of claim 42, wherein the network comprises an enterprise network.
